(19) United States
(12) Patent Application Publication
(10) Pub. No.: US 2011/0224937 A1
(43) Pub. Date: Sep. 15, 2011

(54) CURRENT DETECTOR

(75) Inventor: Keisuke NISHIMURA, Anjo (JP)

(73) Assignee: AISIN AW CO., LTD., ANJO-SHI (JP)

(21) Appl. No.: 13/014,916

(22) Filed: Jan. 27, 2011

(30) Foreign Application Priority Data
Mar. 9, 2010 (JP) 2010-051867

(51) Int. Cl. G06F 19/00

(52) U.S. Cl. 702/106

(57) ABSTRACT

Provided is a current detector that, even when the skin effect occurs in a conductor in which a current flows, can detect the current flowing in the conductor with high accuracy. A sensor part that is provided near a conductor and detects magnetic flux in a predetermined magnetic flux detection direction, a current detection part that detects a current flowing in the conductor based on a detection value of the sensor part, a current frequency acquisition part that acquires a current frequency as a frequency of the current flowing in the conductor, and a correction part that corrects the detection value of the sensor part based on the current frequency are provided.

### INCORPORATION BY REFERENCE

The disclosure of Japanese Patent Application No. 2010-051867 filed on Mar. 9, 2010, including the specification, drawings and abstract thereof, is incorporated herein by reference in its entirety.

### BACKGROUND OF THE INVENTION

1. Field of the Invention

The present invention relates to a current detector that detects a current flowing in a conductor using the Hall effect.

2. Description of Related Art

Motors (rotating electric machines) are often feedback controlled based on detection results of currents flowing in the motor. This current is measured using a current sensor that obtains a current value by detecting magnetic flux generated by the current using a magnetic detection device such as a Hall device, for example. The magnetic flux is generated to surround the current path according to the right-handed screw rule. Accordingly, the detection accuracy has been improved by passing the current path (conductor) through a magnetism collection core of a magnet formed in an annular form and collecting the magnetic flux generated by the current flowing in the current path by the core. However, recently, in response to requests of downsizing of current sensors, reduction of parts, lower costs, coreless sensors without using magnetism collection cores surrounding the current path have been put into practical use. In JP-A-2004-61217, an example of the coreless current sensor is shown.

### SUMMARY OF THE INVENTION

Recently, electric vehicles driven by rotating electric machines and hybrid vehicles driven by internal-combustion engines and rotating electric machines have been put into practical use. Since a large current flows in the rotating electric machine used for a drive system of a vehicle requiring durability, the current is supplied to the rotating electric machine by a thick and rigid conductor (a metal conductor of copper, aluminum, or the like) called a bus bar. The bus bar is often formed in a flat plate having a rectangular sectional shape in a direction orthogonal of the circulation direction of the current as exemplified in FIG. 2 of JP-A-2004-61217 for effective use of the installation space of the drive system, ease of fixation, ease of wiring, etc.

When a current at a high frequency flows in the conductor, the current concentrates on the conductor surface by the skin effect. In the case of the bus bar, the current concentrates on the end surface and the distribution of the magnetic field generated around the bus bar becomes non-uniform in response to the sectional shape of the bus bar. The magnetic detection device is provided with reference to a geometric center position of the bus bar so that its magnetic flux detection direction may be adapted to the magnetic field in the steady state. Accordingly, the magnetic flux density detected by the magnetic detection device in which the distribution of the magnetic field becomes non-uniform with respect to the geometric center position of the bus bar by the skin effect is reduced. As a result, the measurement accuracy of the current may be lower such that the output value of the current sensor may be higher or lower relative to the original value or delays occur in transient response.

Therefore, it is desired to provide a current detector that can detect a current flowing in a conductor with high accuracy even when the skin effect occurs in the conductor in which the current flows.

A characteristic configuration of a current detector according to the invention in view of the above described problems includes:

a sensor part that is provided near a conductor having an outer shape with a sectional shape in which a distance from the center of gravity to an outer peripheral surface is non-uniform and detects magnetic flux in a predetermined magnetic flux detection direction;

a current detection part that detects a current flowing in the conductor based on a detection value of the sensor part;

a current frequency acquisition part that acquires a current frequency as a frequency of the current flowing in the conductor; and

a correction part that corrects the detection value of the sensor part based on the current frequency.

As described above, the skin effect remarkably appears as the frequency of the current flowing in the conductor is higher. According to the configuration, the current detector includes the current frequency acquisition part that acquires the current frequency as the frequency of the current flowing in the conductor. Therefore, the current detector may consider the influence of the skin effect when detecting the current of the conductor based on the detection value of the sensor part. Specifically, the correction part is provided and the detection value of the sensor part is corrected based on the current frequency, and thus, even when the skin effect occurs, the current detector can detect the current flowing in the conductor with high accuracy by suppressing the influence of the skin effect.

Here, in the case where the conductor supplies a drive current when an alternating-current rotating electric machine functions as an electric motor and regenerates a power generation current when the machine functions as a power generator, it is preferable that the current frequency acquisition part acquires the current frequency based on a rotational speed of the alternating-current rotating electric machine. When the alternating-current rotating electric machine is controlled, the rotational speed and the rotational position of the rotor are acquired, and feedback control is performed. Accordingly, in the control unit of the alternating-current rotating electric machine, a rotation detection unit such as a resolver is provided, or a rotation detection part that electrically computes the rotational speed and the rotational position is provided. The frequency of the drive current and the power generation current flowing in the conductor is nearly linear with respect to the rotational speed of the alternating-current rotating electric machine. Therefore, when the alternating-current rotating electric machine is controlled, by acquiring the current frequency using the rotational speed that is nearly almost always acquired, the configuration of the current detector may be simplified.

Further, it is preferable that the current frequency acquisition part acquires the current frequency based on a detection result of the sensor part or the current detection part. The direction of the magnetic flux generated by the current flowing in the conductor is switched depending on the direction of the current. That is, the frequency and the current frequency at which the direction of the magnetic flux is switched are nearly linear. Therefore, the current frequency acquisition part can acquire the current frequency based on the frequency of the magnetic flux detected by the sensor part. Further, the magnetic flux density and the current have linearity, and the current frequency can be acquired from the frequency of the current obtained based on the detection value of the sensor part. Note that “detection value of the sensor part” here is not affected by presence or absence of the correction by the correction part. This is because the amplitude of the alternating current obtained based on the detection value of the sensor part that has been affected by the skin effect is affected by the skin effect, however, the frequency is not affected. Thus, by acquiring the current frequency based on the detection result of the sensor part or the current detection part, a system may be constructed using only the current detector without using another sensor or the like, the configuration of the current detector may be simplified.

It is preferable that the correction part of the current detector according to the invention corrects the detection value by multiplying the detection value of the sensor part by a coefficient in response to the current frequency. By correcting the detection value by multiplication of the coefficient, the configurations the correction part and the current detector may be simplified.

Further, it is preferable that the correction part of the current detector according to the invention corrects the detection value by changing a dynamic range of the sensor part in response to the current frequency. The dynamic range of the sensor part as the functional part at the uppermost stream of the current detector, and thus, the influence of the transmission error, the discrete error at digital conversion, or the like may be suppressed.

Furthermore, it is preferable that the correction part of the current detector according to the invention corrects the detection value based on a map in which a correction value in response to the current frequency is stored. By correcting the detection value based on the map in which the correction value is stored, the current detector may be formed using hardware with low computation performance, and the computation error or the like may be suppressed. Particularly, in the case where the influence by the skin effect is non-linear and may not be approximated to a linear expression or a quadratic expression, the correction based on the map is useful.

Note that, when the sectional shape of the conductor in which the sensor part of the current detector according to the invention is provided is a flat shape including a rectangular shape and an oval shape, the advantage of the invention is even remarkable.

The outer shape of the conductor is the shape in which the distance from the center of gravity to the outer peripheral surface is non-uniform in the sectional shape, and particularly, when it is a flat shape, the non-uniformity of the distance from the center of gravity to the outer peripheral surface is higher. Therefore, the sensor part becomes susceptible to the skin effect. Here, when the current detector includes the above described configuration, the influence by the skin effect is suppressed. In consideration of the productivity and wiring of the conductor, conductors having plate-like shapes or the like with flat sections may often be used. Therefore, with respect to conductors with high frequencies of use, the currents flowing in the conductors can be detected with high accuracy by suppressing the influence of the skin effect.

### BRIEF DESCRIPTION OF THE DRAWINGS

FIG. 1 schematically shows a configuration example of a drive system of a rotating electric machine;

FIG. 2 is a block diagram schematically showing an example of an embodiment of a current detector;

FIG. 3 is a perspective view schematically showing a placement example of a sensor part relative to a bus bar;

FIG. 4 is a sectional view schematically showing the placement example of the sensor part relative to the bus bar;

FIG. 5 is an explanatory diagram showing an influence on magnetic field detection by the skin effect using a sectional view;

FIG. 6 is a graph showing the influence on magnetic field detection by the skin effect using attenuation rate;

FIG. 7 is a block diagram schematically showing an example of a configuration of the current detector;

FIG. 8 is a block diagram schematically showing another example of the configuration of the current detector;

FIG. 9 is a graph schematically showing examples of a correction coefficient;

FIG. 10 is a sectional view schematically showing another placement example of the sensor part relative to the bus bar;

FIG. 11 is a graph showing an influence on magnetic field detection by the skin effect in the placement of FIG. 10 using attenuation rate;

FIG. 12 is a sectional view showing another example of a sectional shape of the bus bar; and

FIG. 13 is a perspective view schematically showing a principle of current detection using a magnetism collection core surrounding a conductor.

### DETAILED DESCRIPTION OF THE PREFERRED EMBODIMENT

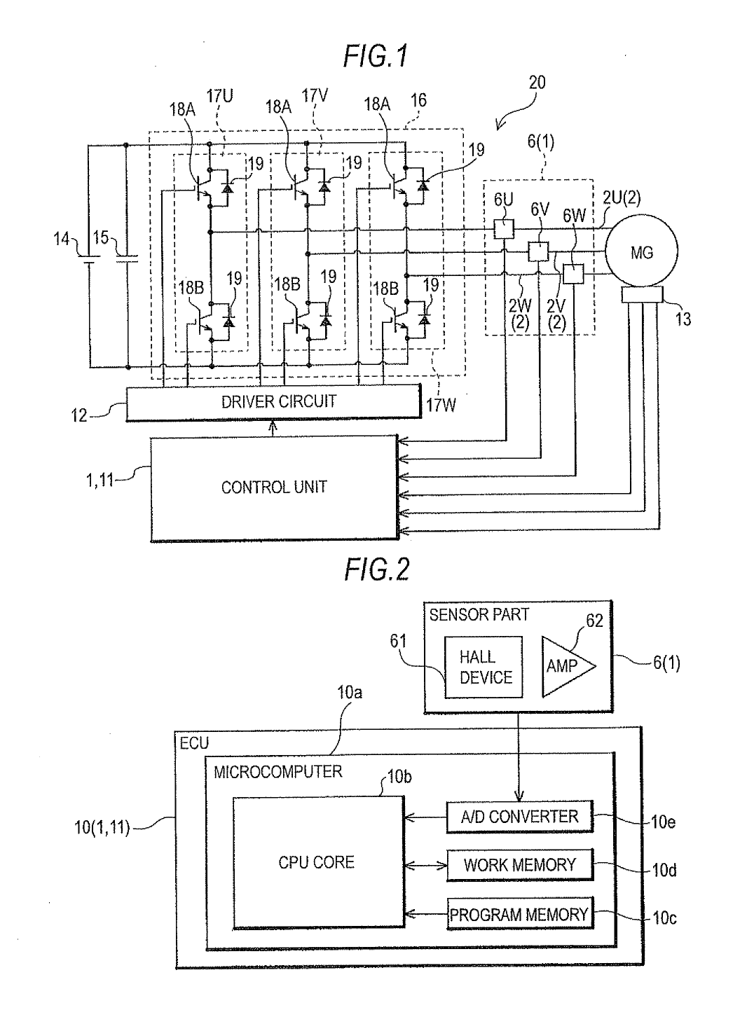

Hereinafter, an embodiment of the invention will be explained by taking a current detector that detects a drive current (power generation current) of alternating-current rotating electric machine as an example. As shown in FIG. 1, in the embodiment, a current detector 1 is applied to a drive system 20 of a rotating electric machine MG driven by three-phase alternating current. The current detector 1 is provided near bus bars (conductors) 2U, 2V, 2W in which the respective drive currents (power generation currents) of the three phases of U-phase, V-phase, W-phase flow. The bus bars 2U, 2V, 2W supply the drive currents when the rotating electric machine MG functions as an electric motor, and regenerate the power generation currents when it functions as a power generator. In the explanation as below, the simple word “bus bar 2” collectively refers to all of U-phase bus bar 2U, V-phase bus bar 2V, and W-phase bus bar 2W.

First, a configuration of the drive system 20 that performs drive control of the rotating electric machine MG will be explained. As shown in FIG. 1, the drive system 20 includes a control unit 11, a driver circuit 12, a rotation detection unit 13, a direct-current power supply 14, a smoothing capacitor 15, and an inverter 16. Here, the direct-current power supply 14 is a rechargeable secondary cell such as a battery or the like. Further, the drive system 20 converts direct-current power of the direct-current power supply 14 into three-phase alternating current at a predetermined frequency and supplies it to the rotating electric machine MG. Furthermore, the drive system 20 converts the alternating-current power generated by the rotating electric machine MG into direct-current and supplies it to the direct-current power supply 14. The rotation detection unit 13 includes a resolver or the like, and outputs detection signals of a rotational speed of the rotating electric machine MG and a rotational position of a rotor to the control unit 11. The smoothing capacitor 15 is connected in parallel between a positive terminal and a negative terminal of the direct-current power supply 14, and smoothes the voltage of the direct-current power supply 14.

The inverter 16 includes plural switching devices. It is preferable to apply IGBT (insulated gate bipolar transistor) and MOSFET (metal oxide semiconductor field effect transistor) to the switching device. As shown in FIG. 1, in the embodiment, the IGBT is used as the switching device. The inverter 16 includes a U-phase leg 17U, a V-phase leg 17V, and a W-phase leg 17W corresponding to the respective phases (three phases of U-phase, V-phase, W-phase) of the rotating electric machine MG, respectively. Each of the legs 17U, 17V, 17W includes a pair of two switching devices including an IGBT 18A in an upper side arm and an IGBT 18B in a lower side arm respectively series-connected. To each of the IGBTs 18A, 18B, a flywheel diode 19 is connected in parallel.

The U-phase leg 17U is connected to a U-phase coil of the rotating electric machine MG via the U-phase bus bar 2U, the V-phase leg 17V is connected to a V-phase coil of the rotating electric machine MG via the V-phase bus bar 2V, and the W-phase leg 17W is connected to a W-phase coil of the rotating electric machine MG via the W-phase bus bar 2W. In this regard, each of the bus bars 2U, 2V, 2W electrically connects between an emitter of the IGBT 18A in the upper side arm and a collector of the IGBT 18B in the lower side arm of each of the phase legs 17U, 17V, 17W and between each phase coil of the rotating electric machine MG. Further, the collector of the IGBT 18A in the upper side arm of each of the legs 17U, 17V, 17W is connected to a high-voltage power supply line connected to the positive terminal of the direct-current power supply 14, and the emitter of the IGBT 18B in the lower side arm of each of the legs 17U, 17V, 17W is connected to a ground line connected to the negative terminal of the direct-current power supply 14.

The inverter 16 is connected to the control unit 11 via the driver circuit 12, and performs switching operation in response to a control signal generated by the control unit 11. The control unit 11 is formed as an ECU (electronic control unit) 10 centering on a logic circuit of a microcomputer 10a or the like as shown in FIG. 2. The ECU 10 includes an interface circuit (not shown) and other peripheral circuits in addition to the microcomputer 10a. The interface circuit includes an EMI (electro-magnetic interference) prevention component, a buffer circuit, etc.

The microcomputer 10a includes a CPU core 10b, a program memory 10c, a work memory 10d, an A/D converter 10e, and further, a. communication control part, a timer, a port, etc. (not shown). The CPU core 10b is the core of the microcomputer 10a, and includes an instruction register, an instruction decoder, an ALU (arithmetic logic unit) as a main unit of execution of various computations, a flag register, a general-purpose register, and an interrupt controller, etc. The program memory 10c is a nonvolatile memory in which a rotating electric machine control program, a current detection program, various parameters referred to when these programs are executed, etc. are stored. The program memory 10c is preferably includes a flash memory or the like, for example. The work memory 10d is a memory that temporarily stores temporary data during execution of programs. The work memory 10d is not problematic to be volatile, and preferably includes a DRAM (dynamic RAM) or SRAM (static RAM) with which reading and writing of data may be performed at high speeds. Here, a form in which the A/D converter 10e and the memories 10c, 10d in addition to the CPU core 10b are integrated in one chip has been shown, however, naturally, the computer system may be constructed by plural chips.

Especially, in the case where the rotating electric machine MG is a drive system of a vehicle or the like, the direct-current power supply 14 is at a high voltage and the respective IGBTs 18A, 18B of the inverter 16 switch the high voltage. The potential difference between the high level and the low level of the pulsed gate drive signals input to the gates of the IGBTs that switch the high voltage is a voltage far higher than the operation voltage of a general electronic circuit such as a microcomputer. Accordingly, the gate drive signals are input to the respective IGBTs 18A, 18B of the inverter 16 after voltage conversion and insulation via the driver circuit 12. Thereby, the inverter 16 converts the direct-current power from the direct-current power supply 14 into three-phase alternating-current power with predetermined frequency and current value and supplies it to the rotating electric machine MG when the rotating electric machine MG functions as an electric motor (at power running operation). Further, the inverter 16 converts the three-phase alternating-current power generated by the rotating electric machine MG into direct-current power and supplies it to the direct-current power supply 14 when the rotating electric machine MG functions as a power generator (at regeneration operation).

In this manner, the rotating electric machine MG is driven with predetermined output torque and rotational speed by the control of the control unit 11. Concurrently, the values of the currents flowing in the stator coils (U-phase coil, V-phase coil, W-phase coil) of the rotating electric machine MG are fed back to the control unit 11. Then, the control unit 11 performs drive control of the rotating electric machine MG by executing P1 control (proportional-integral control) and PID control (proportional-integral-derivative control) in response to the deviations from the target current. Accordingly, the current values flowing in the respective bus bars 2U, 2V, 2W provided between the respective phase legs 17U, 17V, 17W of the inverter 16 and the respective phase coils of the rotating electric machine MG are detected by the current detector 1.

In the embodiment, the current detector 1 includes sensor parts 6 provided for all of the three bus bars 2U, 2V, 2W. That is, the current detector 1 includes a U-phase sensor part 6U for detecting the current of the U-phase bus bar 2U, a V-phase sensor part 6V for detecting the current of the V-phase bus bar 2V, and a W-phase sensor part 6W for detecting the current of the W-phase bus bar 2W. The respective phase sensor parts GU, 6V, 6W detect magnetic flux density of the magnetic fields generated by the currents flowing in the respective phase bus bars 2U, 2V, 2W as targets of detection, and output detection signals in response to the detected magnetic flux density of the magnetic fields. The magnetic flux density in a predetermined position in the magnetic field generated by the current flowing in the bus bar 2 is proportional to the magnitude of the current flowing in the bus bar 2. Therefore, by the respective phase sensor parts 6U, 6V, 6W, the current values flowing in the respective phase bus bars 2U, 2V, 2W may be detected. Note that, since the currents of the respective phases of the three phases are balanced and the instantaneous value is zero, the configuration may detect the current values of only two phases.

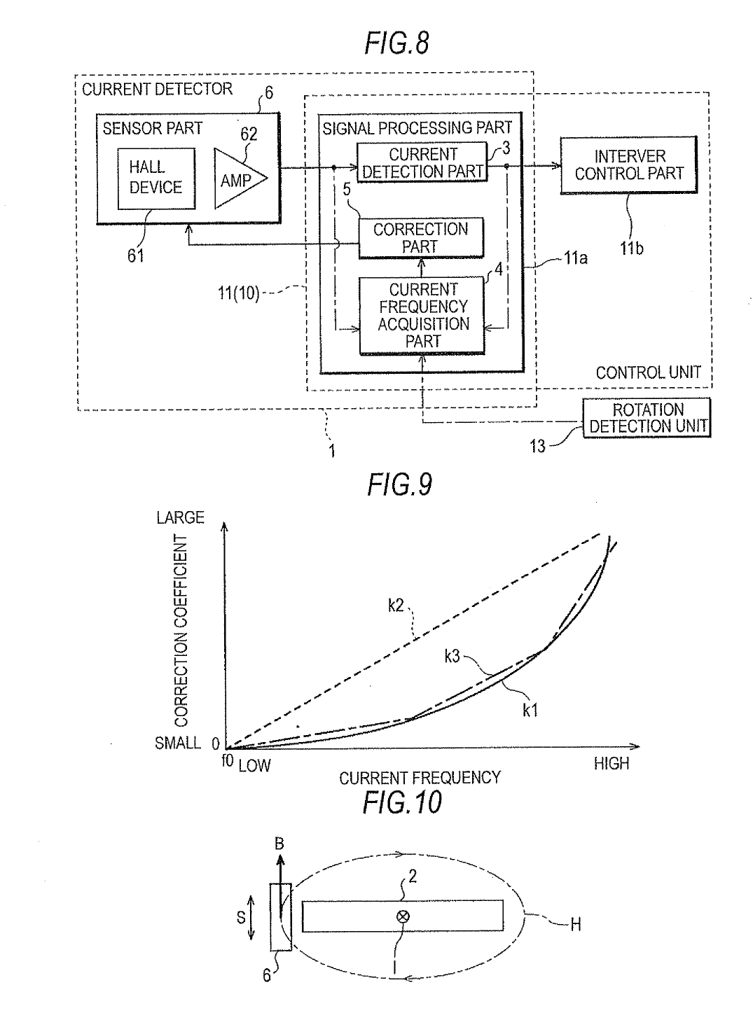

As shown in FIG. 2, in the embodiment, the current detector 1 is formed using the ECU 10. The sensor part 6 outputs the detection value in response to the magnetic flux density as an analog signal to the ECU 10, and the detection value is converted into a digital value by the A/D converter 10e of the ECU 10. Then, the detection value in response to the magnetic flux density is converted into a current value by cooperation of hardware such as the CPU core 10b and the work memory 10d of the microcomputer 10a and software such as a current detection program stored in the program memory 10c. The functional part that functions as the current detector 1 by the cooperation of the hardware and the software in the ECU 10 of the embodiment is referred to as a signal processing part 11a in the control unit 11 (see FIGS. 7 and 8). Obviously, the embodiment is just an example, and the current value may be obtained in an analog signal as it is using an operation amplifier or the like, or the current value may be obtained not using software but using only hardware.

To the ECU 10 that also functions as the control unit 11, not only the detection values by the respective phase sensor parts 6U, 6V, 6W of the current detector 1 but also the detection signal of the rotational speed and the rotational position of the rotating electric machine MG by the rotation detection unit 13 are input. The microcomputer 10a generates control signals of the respective IGBTs 18A, 18B of the inverter 16 by cooperation with hardware such as the CPU core 10b and software such as the rotating electric machine control program stored in the program memory 10c based on the detection values and the detection signals. The generated control signals are output to the inverter 16 via the driver circuit 12 as described above. The functional part that controls the inverter 16 by the cooperation with hardware and software in the ECU 10 of the embodiment is referred to as an inverter control part 11b in the control unit 11 (see FIGS. 7 and 8).

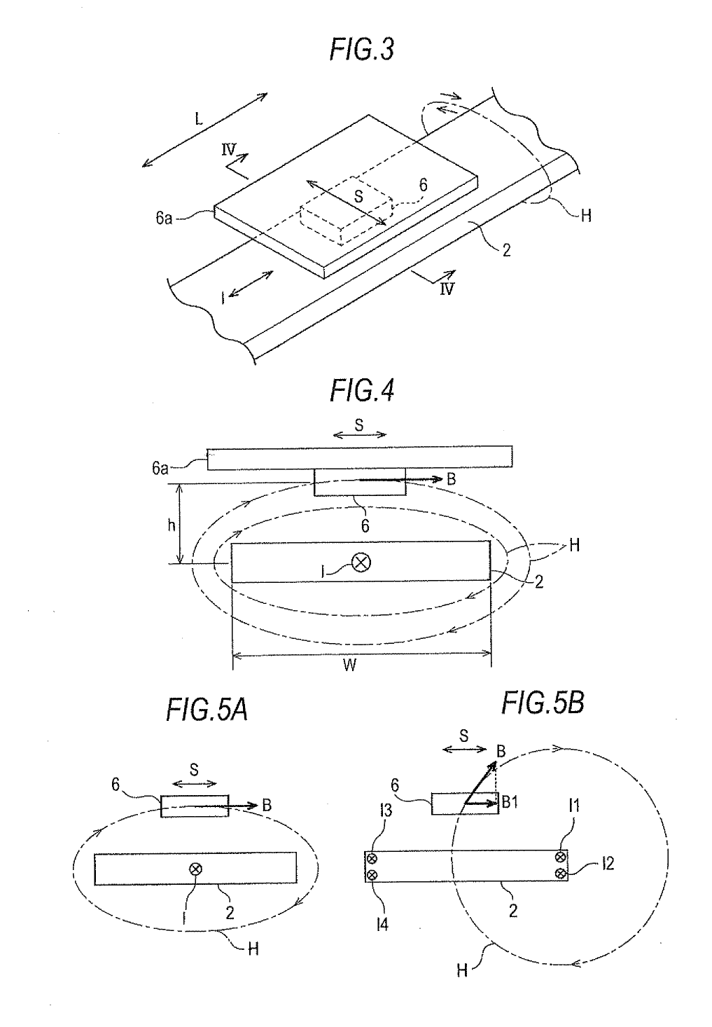

The arrangements of the respective phase bus bars 2U, 2V, 2W and the respective phase sensor parts 6U, 6V, 6W and the configurations of the phase sensor parts 6U, 6V, 6W are the same, and they will be explained simply as the bus bar 2 and the sensor part 6 as below. As shown in FIG. 3 and FIG. 4 as a sectional view of FIG. 3, the sensor part 6 is provided near the bus bar 2. In the embodiment, the bus bar 2 is a plate-like conductor having a rectangular flat sectional shape orthogonal to the direction in which the current flows, and includes a metal such as copper or aluminum. In the embodiment, the sensor part 6 is provided near the extension surface of the bus bar 2 located at the long side (longitudinal side, long axis side) of the section. In this regard, no magnetism collection core 30 as shown in FIG. 13, i.e., no magnetism collection core 30 of a magnet surrounding a conductor 2A is provided. The magnetism collection core 30 is a magnet core having a C-shaped section with a gap, and concentrates the magnetic flux generated by the current flowing in the conductor 2A and guides it to a sensor part 6A provided in the gap. Therefore, the current detector 1 of the embodiment is the so-called coreless current detector in which the sensor part 6 is provided with no magnetism collection core surrounding the conductor. Note that a sensor device formed by integrating a magnet for changing the direction of magnetic flux or locally concentrating magnetic flux with a Hall device has been put into practice. However, even in the case where such a sensor device is used as the sensor part 6, here, the detector is handled as a coreless current detector as long as it uses no magnetism collection core surrounding the conductor.

The sensor part 6 is formed using various magnetic detection devices such as a Hall device, an MR (magnetoresistive effect) device or an MI (magnetic impedance) device, for example. In the embodiment, the sensor part 6 is formed as an integrated circuit (IC) chip in which a Hall device 61 and a buffer amplifier 62 that at least impedance-converts the output of the Hall device 61 are integrated. Further, the IC chip is mounted on a substrate 6a and provided near the bus bar 2. In FIGS. 3 and 4, though omitted, the substrate 6a and the ECU 10 are connected via a power supply line that drives the IC chip as the sensor part 6 and a signal line that transmits the detection value by the sensor part 6. Note that the sensor part 6 is provided so that the detection center position may coincide with the center at the long side of the section of the bus bar 2 (for example, see FIG. 4).

In the embodiment, the IC chip as the sensor part 6 has a configuration that can detect magnetic flux in parallel to the chip surface of the IC chip, here, magnetic flux in parallel to the extension surface located at the long side of the section of the bus bar 2 as shown in FIGS. 3 and 4. That is, the sensor part 6 is formed to detect only magnetic flux density B of the magnetic flux in a predetermined magnetic flux detection direction S. Since the current flowing in the bus bar 2 is an alternating current, the magnetic flux detection direction S includes two directions opposite to each other as shown in FIGS. 3 and 4. In FIG. 4, to facilitate understanding, lines of magnetic force H in the case where current I flows from front to rear of the paper surface are exemplified, and the magnetic flux density B in this case is exemplified.

As shown in FIGS. 3 and 4, each sensor part 6 has one bus bar 2 as a target of detection and detects magnetic flux (magnetic flux density B) generated by the flow of current I in the bus bar 2 for detection of the current I flowing in the bus bar 2. As is obvious, the nearer the bus bar 2, the stronger the magnetic field and the larger the magnetic flux density B. Accordingly, the sensor part 6 is provided near the bus bar 2. If the temperature resistance and vibration resistance are satisfied, the sensor part 6 may be provided in contact with the bus bar 2. In the embodiment, as shown in FIGS. 3 and 4, the sensor part 6 is provided at a predetermined distance (h) apart from the bus bar 2. In this regard, the sensor part 6 is provided so that the magnetic flux detection direction S and the extension direction L of the bus bar 2 may be nearly orthogonal. The extension direction L of the bus bar 2 corresponds to the circulation direction of the current, and thus, strong magnetic flux is obtained in the sensor part 6. As shown in FIG. 4, given that the distance between the center of the bus bar 2 (the center of the current I) and the center of the sensor part 6 (the center of the Hall device) is h, and the length of the long side of the section of the bus bar 2 (the opposed side to the sensor part 6) is W, when the current I [A] flows in the bus bar 2, the magnetic flux density B [T=Wb/m²] at the center of the sensor part 6 is expressed by the following equation with the permeability in vacuum as

μ₀[H/m=Wb/A·m]. [Eq. 1]

Now, when a current flows in a conductor, if the frequency of the current becomes higher, the current non-uniformly flows in the conductor by the skin effect and concentrates on the surface of the conductor. FIGS. 5A and 5B show an influence of the skin effect for magnetic field detection using the same sectional view as FIG. 4. FIG. 5A shows the case where the current I uniformly flows in the bus bar 2, showing the current I at the center like in FIG. 4 for convenience. In this case, the tangential line of the line of magnetic force H passing through the sensor part 6 and the magnetic flux detection direction S are in parallel, and all components of the magnetic flux density B in the sensor part 6 are detected by the sensor part 6.

FIG. 5B shows the case where the current flows while deflecting toward the surface of the bus bar 2 by the skin effect, and the current I is shown as currents I1, I2, I3, I4 dispersedly flowing at the respective apexes of the rectangular section farthest from the center for convenience. Further, FIG. 5B representatively shows the line of magnetic force H of the magnetic field by the current I1 of the currents flowing at the respective apexes. In this case, the tangential line of the line of magnetic force H passing through the sensor part 6 and the magnetic flux detection direction S are not in parallel. Of the magnetic flux density B in the sensor part 6, only the magnetic flux density B1 as a component in parallel to the magnetic flux detection direction S according to vector decomposition is detected by the sensor part G. Accordingly, the detected magnetic flux density B (B1) takes a value attenuated for the current I flowing in the bus bar 2. Further, the relative distances between the currents I1, I2, I3, I4 dispersed at the respective apexes and the sensor part 6 are longer compared to that in FIG. 5A, and the amount of magnetic flux in the sensor part 6 is smaller. Accordingly, the detected magnetic flux density B takes a value attenuated for the current I flowing in the bus bar 2.

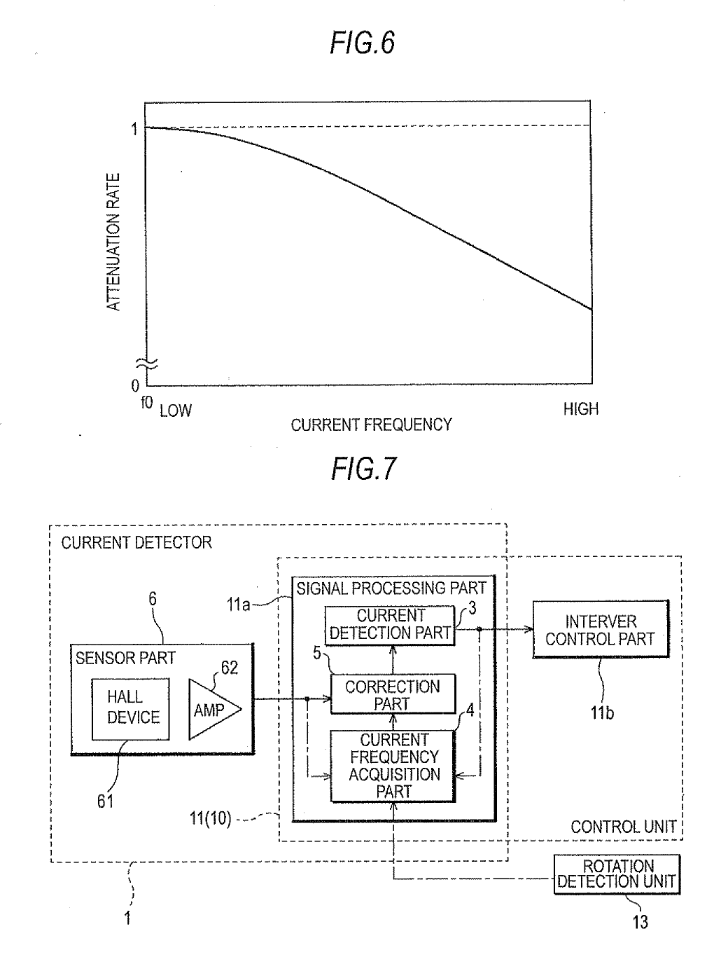

As the current frequency becomes higher, the skin effect becomes more remarkable, and the attenuation rate of the magnetic flux density detected in the sensor part 6 becomes higher as the current frequency becomes higher. FIG. 6 is a graph showing the attenuation rate. FIG. 6 shows the attenuation rate in response to the current frequency with the attenuation rate at the current frequency equal to or less than f0 at which the skin effect starts to appear as “1”.

The current detector 1 suppresses the influence of the skin effect and detects the magnetic flux density B with high accuracy, and detects the current I based on the detected magnetic flux density B (detection value). Accordingly, the current detector 1 includes a current frequency acquisition part 4 that acquires the current frequency as the frequency of the current I flowing in the bus bar 2, and a correction part 5 that corrects the detection value of the sensor part 6 based on the current frequency as shown in FIGS. 7 and 8. The magnetic flux density B is detected by the sensor part 6 provided near the bus bar 2 as described above. Further, the value of the current I is computed by a current detection part 3 based on the above described equation (1).

As shown in FIGS. 7 and 8, in the embodiment, the current detector 1 includes the sensor part 6 and the signal processing part 11a. Further, the signal processing part 11a is formed together with the inverter control part 11b in the ECU 10 forming the control unit 11. In the embodiment, as shown in FIGS. 1 and 2, the case where the signal processing part 11a and the inverter control part 11b are formed using the same microcomputer 10a in the same ECU 10 is exemplified, however, not limited to that. They may be formed in different ECUs, or, even in the case where they are formed in the same ECU, they may be formed using different microcomputers.

The current frequency acquisition part 4 acquires the current frequency as the frequency of the current I flowing in the bus bar 2 according to any one or a combination of some of the following methods (a) to (d). (a) The bus bar 2 serves as a supply path of an alternating drive current when the rotating electric machine MG functions as an electric motor and serves as a regeneration path of an alternating power generation current when the rotating electric machine MG functions as a power generator. The frequencies of the drive current and the power generation current depend on the number of rotations of the rotating electric machine MG. Therefore, the current frequency acquisition part 4 can compute and acquire the current frequency based on the detection result of the rotation detection unit 13 that detects the number of rotations of the rotating electric machine MG.

(b) Further, regarding the magnetic field generated by the current I flowing in the bus bar 2, the direction of the line of magnetic force is switched depending on the direction of the current I. That is, the frequency at which the direction of magnetic flux is switched depends on the frequency of the current I. Therefore, the current frequency acquisition part 4 can compute and acquire the current frequency based on the frequency of the magnetic flux density B detected by the sensor part 6.
(c) Furthermore, as is clear from the above described equation (1), the magnetic flux density B is proportional to the current I. Therefore, the current frequency acquisition part 4 may acquire the current frequency directly from the frequency of the current computed by the current detection part 3 based on the magnetic flux density B.
(d) In addition, in the embodiment, the signal processing part 11a and the inverter control part 11b are formed using the same microcomputers 10a in the same ECU 10. Therefore, the current frequency acquisition part 4 may acquire the current frequency by acquiring the frequency of the target current, the voltage frequency of the inverter 16, or the like from the inverter control part 11b.

The correction part 5 corrects the detection value of the sensor part 6 by correcting the output value of the sensor part 6 before the current detection part 3 uses it as one aspect (see FIG. 7). Or, the correction part 5 corrects the detection value of the sensor part 6 by changing the dynamic range of the sensor part 6 as one aspect (see FIG. 8). Here, the changing of the dynamic range refers to changing of the power supply voltage of the sensor part 6 including the IC chip and the drive voltage applied to the Hall device 61, or changing of the power supply voltage or the gain of the buffer amplifier 62.

As shown in FIG. 6, in the embodiment, the attenuation rate of the magnetic flux density B detected by the sensor part 6 becomes higher as the current frequency becomes higher. Therefore, as one aspect in the configuration of FIG. 7, the correction part 5 corrects the detection value of the sensor part 6 by multiplying the output value (detection value) of the sensor part 6 by a correction coefficient k that becomes larger as the current frequency becomes higher. FIG. 9 is a graph showing examples of the correction coefficient k. As the correction coefficient k1, a correction coefficient k obtained by approximation of the curve of the attenuation rate shown in FIG. 6 to a quadratic curve for cancelling out is exemplified. As the correction coefficient k2, a correction coefficient k obtained by linear approximation is exemplified. As the correction coefficient k3, a correction coefficient k obtained by further linear approximation of the quadratic curve formed by approximation of the curve of the attenuation rate for cancelling out with respect to each region is exemplified.

Further, the correction part 5 may correct the detection value of the sensor part 6 by referring to a correction coefficient map in which correction coefficients k in response to the current frequencies are stored without using the correction coefficient k approximated to a line or curve. Further, as one aspect, the correction part 5 may correct the detection value of the sensor part 6 by referring to a map (correction map) in which correction values in response to the current frequencies are stored. For example, a map for reference to the detection value after correction using the current frequency and the detection value of the sensor part 6 as arguments is preferable. Such a map is stored in the program memory 10c, for example.

Further, as one aspect in the configuration of FIG. 8, the correction part 5 may correct the detection value of the sensor part 6 by making the dynamic range of the sensor part 6 wider as the current frequency becomes higher. The ratio with which the dynamic range is made wider is the same as the above described correction coefficient k. That is, the dynamic range is made wider to cancel out the curve of the attenuation rate shown in FIG. 6. The correction part 5 may change the dynamic range using the coefficient approximated to a line or curve like the correction coefficient k, or may change the dynamic range by referring to a map (range map) in which values in response to the current frequencies are stored. Further, the correction part 5 may change the dynamic range by referring to a map (voltage map or gain map) in which values of the power supply voltage and values of gain in response to the current frequencies are stored. The map may also be stored in the program memory 10c, for example.

### Other Embodiments

In the above described embodiment, the case where the sensor part 6 is provided so that the sectional shape orthogonal to the direction in which the current flows may be opposed to the extension surface located at the longitudinal side (long side, long axis side) in the section of the bus bar 2 has been explained as an example. However, not limited to the embodiment, but, as shown in FIG. 10, the sensor part 6 may be provided to be opposed to the extension surface located at the lateral side (short side, short axis side) in the section of a flat shape of the bus bar 2. Note that, in this case, if the current I concentrates on the end surface of the bus bar 2 as shown in FIG. 5B by the skin effect, the center of the generated magnetic field will be closer to the sensor part 6 without shifting from the geometric center of the sensor part 6.

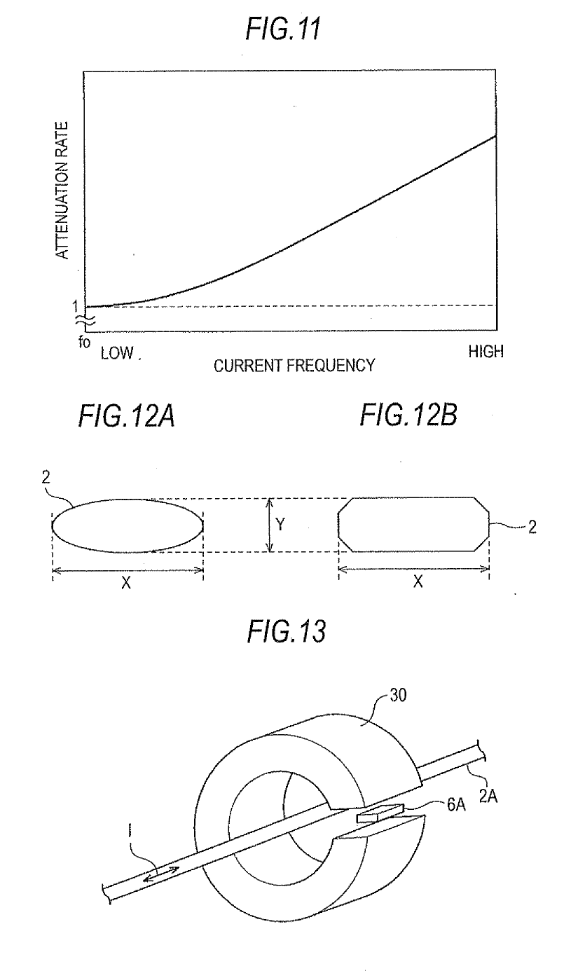

Accordingly, unlike the embodiment, the direction of the magnetic flux in the magnetic flux detection direction S does not change even when the skin effect occurs, and oppositely, the magnetic flux density B in the sensor part 6 increases. FIG. 11 is a graph corresponding to FIG. 6 showing the attenuation rate of the detection value when the current frequency is equal to or less than f0 at which the skin effect starts to appear, however, in this case, the magnetic flux density B increases by the skin effect. The attenuation rate takes a value more than “1”, and becomes equivalent to gain. Therefore, by using the correction coefficient k having a generally opposite characteristic to that in FIG. 9 or the like, the detection value of the sensor part 6 can be corrected in the above described manner. The block configuration of the current detector 1 is the same as that shown in FIGS. 7 and 8 except the value of the correction coefficient k. Corresponding specific examples and detailed explanation of the correction coefficient k in FIG. 9 will be omitted because a person skilled in the art could easily understand.

Further, in the above described embodiment, the case where the shape of the conductor such as the bus bar 2 or the like is a rectangular shape has been explained as an example, however, obviously, the sectional shape of the conductor may not be limited to the rectangular shape. In the sectional shape, as long as the conductor has an outer shape in which the distance from the center of gravity or the geometric center to the outer peripheral surface is non-uniform, because the sensor part 6 is affected by the skin effect, the invention may be applied thereto. That is, the sensor part 6 is affected by the skin effect even when the sectional shape of the conductor has a square, diamond, or regular triangle shape, not or not near a true circle shape. Therefore, the sectional shape of the conductor orthogonal to the direction in which the current flows may be a square, diamond, or regular triangle shape.

Further, even in the case where the section is a flat shape, the sectional shape may be an oval or polygonal shape as shown in FIG. 12. The influence of the skin effect is easier to appear as the ratio between the long axis X and the short axis Y shown in FIG. 12, i.e., the aspect ratio is higher. A person skilled in the art could apply the invention even when the shape of the bus bar 2 is another than the rectangular shape by reading “long side of the rectangular shape” into “long axis” and “short side of the rectangular shape” into “short axis” in the above explanation. Furthermore, the current detector of the invention may be applied not only to the current flowing in the alternating-current rotating electric machine but also to wide use of alternating current detection. However, obviously, the modification including the scope of the invention also belongs to the technical range of the invention.

The invention may be applied to a current detector that detects an alternating current as a current flowing in an alternating-current rotating electric machine or the like. In view of the skin effect and the right-handed screw rule of Ampere, the influence of the skin effect can be reduced by forming the sectional shape of the conductor in a circular or polygonal shape with many apexes. However, in the case where it is difficult to form the sectional shape of the conductor in a circular or regular polygonal shape for circulation of large current or due to restrictions of installation space, the current detector according to the invention is preferable. Especially, the invention may preferably be applied to a current detector in a rotating electric machine used for a drive system of a vehicle with large current flowing therein and many restrictions of installation space.

What is claimed is:

1. A current detector comprising:
a sensor part that is provided near a conductor having an outer shape with a sectional shape in which a distance from the center of gravity to an outer peripheral surface is non-uniform and detects magnetic flux in a predetermined magnetic flux detection direction;
a current detection part that detects a current flowing in the conductor based on a detection value of the sensor part;
a current frequency acquisition part that acquires a current frequency as a frequency of the current flowing in the conductor; and
a correction part that corrects the detection value of the sensor part based on the current frequency.

2. The current detector according to claim 1, wherein the conductor supplies a drive current when an alternating-current rotating electric machine functions as an electric motor and regenerates a power generation current when the machine functions as a power generator, and the current frequency acquisition part acquires the current frequency based on a rotational speed of the alternating-current rotating electric machine.

3. The current detector according to claim 2, wherein the correction part corrects the detection value by multiplying the detection value of the sensor part by a coefficient in response to the current frequency.

4. The current detector according to claim 2, wherein the correction part corrects the detection value by changing a dynamic range of the sensor part in response to the current frequency.

5. The current detector according to claim 2, wherein the correction part corrects the detection value based on a map in which a correction value in response to the current frequency is stored.

6. The current detector according to claim 1, wherein the current frequency acquisition part acquires the current frequency based on a detection result of the sensor part or the current detection part.

7. The current detector according to claim 6, wherein the correction part corrects the detection value by multiplying the detection value of the sensor part by a coefficient in response to the current frequency.

8. The current detector according to claim 6, wherein the correction part corrects the detection value by changing a dynamic range of the sensor part in response to the current frequency.

9. The current detector according to claim 3, wherein the correction part corrects the detection value based on a map in which a correction value in response to the current frequency is stored.

10. The current detector according to claim 1, wherein the correction part corrects the detection value by multiplying the detection value of the sensor part by a coefficient in response to the current frequency.

11. The current detector according to claim 1, wherein the correction part corrects the detection value by changing a dynamic range of the sensor part in response to the current frequency.

12. The current detector according to claim 1, wherein the correction part corrects the detection value based on a map in which a correction value in response to the current frequency is stored.

13. The current detector according to claim 1, wherein the sectional shape is a flat shape including a rectangular shape and an oval shape.
